(19) United States
(12) Patent Application Publication
(10) Pub. No.: US 2015/0375374 A1
(43) Pub. Date: Dec. 31, 2015

(54) Adjustable Wrench

(71) Applicant: Ruqian Zhang, Hangzhou (CN)

(72) Inventor: Ruqian Zhang, Hangzhou (CN)

(21) Appl. No.: 14/316,346

(22) Filed: Jun. 26, 2014

(51) Int. Cl. B25B 13/14

(52) U.S. Cl. CPC B25B 13/14

(57) ABSTRACT

An infinitely variable speed and multi-functional wrench has a wrench body. The sockets are arranged at two ends of the wrench body. An adjustment screw bolt is arranged on the wrench body. An adjustable wrench support matches with sockets and are separately arranged on two ends of the adjustment screw bolts. An adjustment threaded sleeve is arranged between the adjustment wrench support and the adjustment screw bolt. An adjustable button fixed with the adjustment screw bolt is arranged on the adjustment screw bolt. The spacing between the sockets and the adjustable wrench support can be adjustment with the adjustable button. The diameters of the wrench holes at two ends of the wrench body varies with each other.

### FIELD OF THE INVENTION

The present invention relates to a utility wrench, especially to a continuously variable and multi-functional wrench.

### BACKGROUND OF THE INVENTION

Traditionally, wrenches were fixed in size, however more recently, adjustable wrenches have been designed. Adjustable bore diameter wrenches can be easier to use.

### SUMMARY OF THE INVENTION

An infinitely variable speed and multi-functional wrench has a wrench body. The sockets are arranged at two ends of the wrench body. An adjustment screw bolt is arranged on the wrench body. An adjustable wrench support matches with sockets and are separately arranged on two ends of the adjustment screw bolts. An adjustment threaded sleeve is arranged between the adjustment wrench support and the adjustment screw bolt. An adjustable button fixed with the adjustment screw bolt is arranged on the adjustment screw bolt. The spacing between the sockets and the adjustable wrench support can be adjustment with the adjustable button. The diameters of the wrench holes at two ends of the wrench body varies with each other.

Preferably, an adjustment placement frame is arranged in the wrench body. The adjustment screw bolt is arranged in the adjustment placement frame. An adjustment placement slot is placed and adjusted with the adjustable button arranged on the adjustment placement frame. The adjustment placement slot is arranged in an adjustment cover. The adjustment cover is fixed with the wrench body. A screw placement slot is separately arranged on the two ends of the wrench body and the screw placement slot can be placed and adjusted with the adjustment screw sleeve through a placement rod. Preferably, a mating slot matches with the wrench hole and is arranged on the outer wall of the adjustment wrench support. The cross section of the mating slot is preferably triangular. Preferably, the wrench body is made of plastic or metal.

The pore diameter of the sockets on the left and right side may vary dependant on actual conditions and also can be different dimensions.

The adjustable wrench optionally has the adjustable button retained to the wrench body by the adjustment cover. The adjustable button has a protrusion on an underside of the adjustable button that protrudes into and engages a helical groove formed on the adjustment screw bolt. A thread angle of the helical groove is preferably less than a thread angle of the adjustment threaded sleeve. A pitch of the helical groove is preferably less than a pitch of the adjustment threaded sleeve. A lead of the helical groove is preferably more than a lead of the adjustment threaded sleeve.

### BRIEF DESCRIPTION OF THE DRAWINGS

FIG. 1 is a diagram of the present invention with the adjustment cover removed so that the helical groove is exposed.

FIG. 2 is a perspective top view of the present invention.

FIG. 3 is a perspective bottom view of the present invention.

FIG. 4 is a perspective view of the moving parts of the invention with the wrench body removed to show the adjustable button protrusion engaging the helical groove of the adjustment screw bolt.

The following call out list of elements can be a useful guide in referencing the elements of the drawings.

1 Wrench Body

2 Sockets

3 Adjustment Screw Bolt

4 Adjustable Wrench Support

5 Adjustment Threaded Sleeve

6 Threaded Wall

7 Adjustable Button

8 Adjustment Placement Frame

9 Adjustment Placement Slot

10 Adjustment Cover

11 Screw Placement Slot

12 Placement Rod

13 Mating Slot

14 Helical Groove

15 Adjustable Button Protrusion

16 Adjustment Screw Bolt Bearings

### DETAILED DESCRIPTION OF THE PREFERRED EMBODIMENT

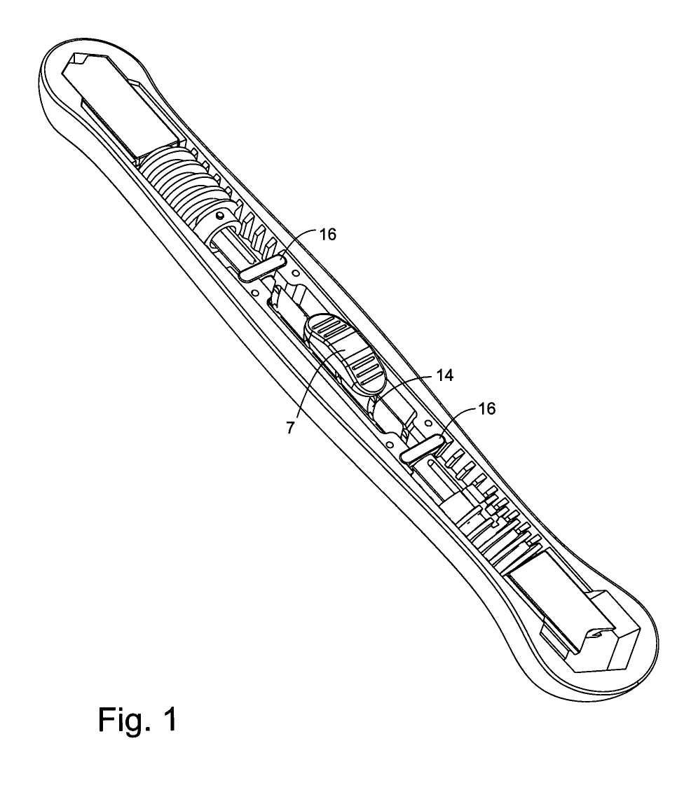

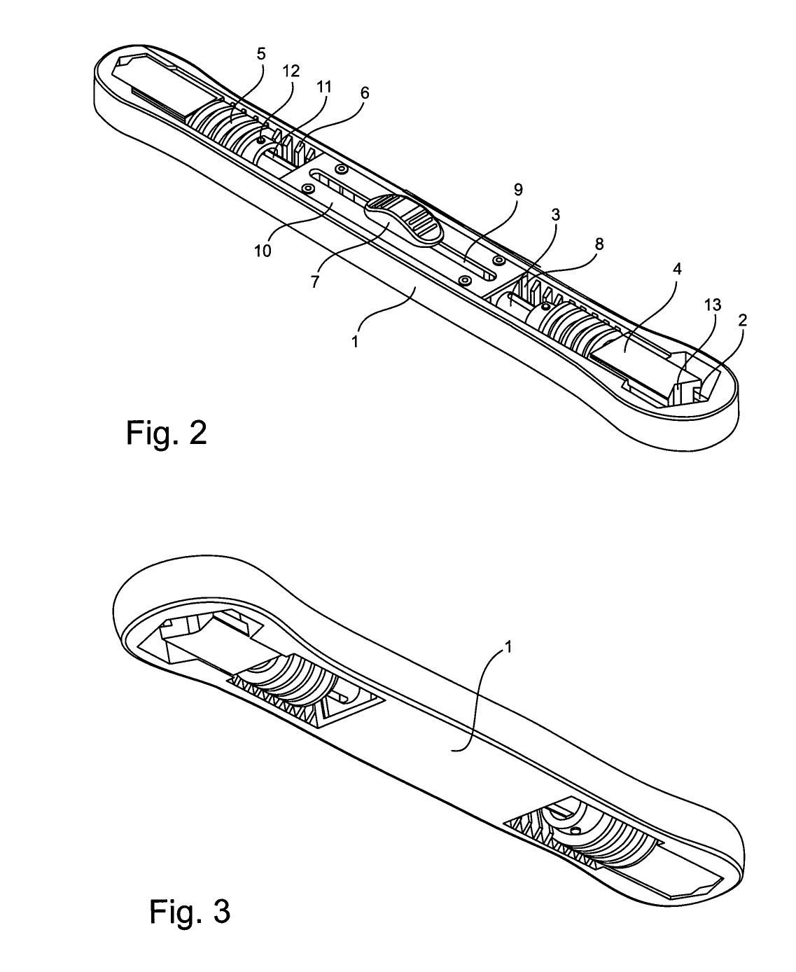

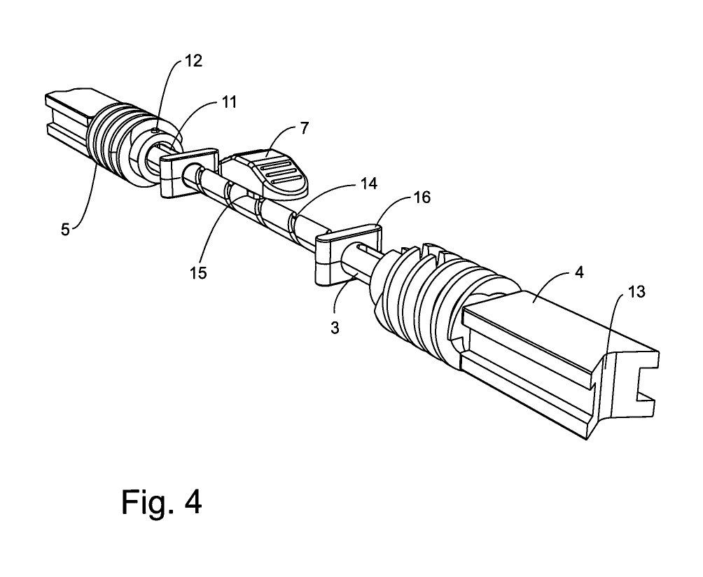

As indicated in FIGS. 1-3, an adjustable wrench has a wrench body 1. Sockets 2 are arranged at two ends of the wrench body 1. An adjustment screw bolt 3 is arranged on the wrench body 1. An adjustable wrench support 4 matches with sockets 2 separately arranged on two ends of the adjustment screw bolts 3. An adjustment threaded sleeve 5 is arranged between the adjustment wrench support 4 and the adjustment screw bolt 3. The adjustment screw sleeve 5 is screwed with the threaded wall 6 of the inner wall of the wrench body 1. An adjustable button 7 fixed with the adjustment screw bolt 3 is arranged on the adjustment screw bolt 3. The spacing between the sockets 2 and the adjustable wrench support 4 can be adjusted with the adjustable button 7 and the diameters of the socket 2 made as adjustable size openings at two ends of the wrench body 1 can vary relative to each other.

An adjustment placement frame 8 is arranged in the wrench body 1. The adjustment screw bolt 3 is arranged in the adjustment placement frame 8. An adjustment placement slot 9 to be placed and adjusted with the adjustable button 7 arranged on the adjustment placement frame 8. The adjustment placement slot 9 is arranged in an adjustment cover 10. The adjustment cover 10 is fixed with the wrench body 1. A screw placement slot 11 is separately arranged on the two ends of the wrench body 1. The screw placement slot 11 can be placed and adjusted with the adjustment screw sleeve 5 through a placement rod 12. A mating slot 13 matches with the wrench hole 2 arranged on the outer wall of the adjustment wrench support 4. The cross section of the mating slot 13 is triangular. The wrench body 1 is made of plastic or metal.

As seen in FIG. 1, the adjustable button 7 is mounted in the wrench body 1 so that adjustable button slides relative to the wrench body. The adjustable button 7 can be retained to the wrench body 1 by the adjustment cover 10. The adjustable button 7 has a protrusion that protrudes into a helical groove 14 formed on the adjustment screw bolt 3. With the adjustment cover 10 removed, the helical groove 14 is seen on a middle portion of the adjustment screw bolt 3. The adjustable button protrusion 15 travels along the helical groove 14 as the user moves the adjustable button 7 along the adjustment placement slot 9. Since the helical groove 14 is helical rather than straight, the translational motion of the adjustable button 7 actuates a rotational motion of the adjustment screw bolt 3. The turning of the adjustment screw bolt turns the adjustment placement slot 11 on both ends, and the adjustment placement slot 11 then rotates to impart rotation to the placement rod 12. When the placement rod 12 rotates, the adjustment threaded sleeve 5 is rotated so that the adjustment threaded sleeve 5 cooperates with the sidewalls of the adjustment placement frame 8 to push the adjustable wrench support 4.

The adjustable wrench support 4 is mounted in the adjustment placement frame 8 so that it translates relative to the adjustment placement frame 8. The adjustable wrench support is pivotally connected to the adjustment threaded sleeve 5 so that the adjustment threaded sleeve 5 rotates relative to the adjustable wrench support 4. The adjustable wrench support 4 does not rotate relative to the wrench body 1. The adjustment threaded sleeve 5 rotates relative to the wrench body 1. The placement rod 12 is rigidly mounted to the adjustment threaded sleeve 5. The placement rod 12 slides along the screw placement slot 11 when the adjustable button 7 is actuated. The adjustment screw bolt 3 is preferably held in a pair of adjustment screw bolt bearings 16.

More specifically, the helical groove can be formed in the adjustment screw bolt by casting, or by milling. The pitch of the helical groove is preferably less than the pitch of the adjustment threaded sleeve. The lead of the helical groove is preferably more than the lead of the adjustment threaded sleeve. Also, the thread angle of the helical groove is preferably less than the thread angle of the adjustment threaded sleeve.

1. An adjustable wrench comprising:
a. a wrench body;
b. sockets arranged at two ends of the wrench body;
c. an adjustment screw bolt arranged on the wrench body;
d. an adjustable wrench support matching with sockets separately arranged on two ends of the adjustment screw bolt;
e. an adjustment threaded sleeve arranged between the adjustment wrench support and the adjustment screw bolt, wherein the adjustment threaded sleeve is screwed with the threaded wall of the inner wall of the wrench body; and
f. an adjustable button fixed with the adjustment screw bolt arranged on the wrench body, wherein the adjustable button is between the sockets, wherein the adjustable wrench support is configure to be adjustable with the adjustable button and the diameters of the sockets at two ends of the wrench body vary from each other.

2. The adjustable wrench of claim 1, wherein an adjustment placement frame is arranged in the wrench body, wherein the adjustment screw bolt is fits at least partially within the adjustment placement frame, wherein an adjustment placement slot is placed and adjusted with the adjustable button arranged on the adjustment placement frame, wherein the adjustment placement slot is arranged in an adjustment cover, wherein the adjustment cover is fixed with the wrench body, wherein a screw placement slot is separately arranged on the two ends of the wrench body and wherein the screw placement slot is adjusted by the adjustment screw sleeve through a placement rod.

3. The adjustable wrench of claim 1, wherein a mating slot matches with the sockets arranged on the outer wall of the adjustment wrench support and, wherein the cross section of the mating slot is triangular.

4. The adjustable wrench of claim 1, wherein the wrench body is made of plastic or metal.

5. The adjustable wrench of claim 1, wherein the adjustable button is retained to the wrench body by the adjustment cover.

6. The adjustable wrench of claim 1, wherein the adjustable button has a protrusion on an underside of the adjustable button that protrudes into and engages a helical groove formed on the adjustment screw bolt.

7. The adjustable wrench of claim 6, wherein an adjustment placement frame is arranged in the wrench body, wherein the adjustment screw bolt is fits at least partially within the adjustment placement frame, wherein an adjustment placement slot is placed and adjusted with the adjustable button arranged on the adjustment placement frame, wherein the adjustment placement slot is arranged in an adjustment cover, wherein the adjustment cover is fixed with the wrench body, wherein a screw placement slot is separately arranged on the two ends of the wrench body and wherein the screw placement slot is adjusted by the adjustment screw sleeve through a placement rod.

8. The adjustable wrench of claim 6, wherein a mating slot matches with the sockets arranged on the outer wall of the adjustment wrench support and, wherein the cross section of the mating slot is triangular.

9. The adjustable wrench of claim 6, wherein the wrench body is made of plastic or metal.

10. The adjustable wrench of claim 6, wherein the adjustable button is retained to the wrench body by the adjustment cover.

11. The adjustable wrench of claim 6, wherein a thread angle of the helical groove is less than a thread angle of the adjustment threaded sleeve.

12. The adjustable wrench of claim 6, wherein a lead of the helical groove is more than a lead of the adjustment threaded sleeve.

13. The adjustable wrench of claim 12, wherein an adjustment placement frame is arranged in the wrench body, wherein the adjustment screw bolt is fits at least partially within the adjustment placement frame, wherein an adjustment placement slot is placed and adjusted with the adjustable button arranged on the adjustment placement frame, wherein the adjustment placement slot is arranged in an adjustment cover, wherein the adjustment cover is fixed with the wrench body, wherein a screw placement slot is separately arranged on the two ends of the wrench body and wherein the screw placement slot is adjusted by the adjustment screw sleeve through a placement rod.

14. The adjustable wrench of claim 12, wherein a mating slot matches with the sockets arranged on the outer wall of the adjustment wrench support and, wherein the cross section of the mating slot is triangular.

15. The adjustable wrench of claim 12, wherein the wrench body is made of plastic or metal.

16. The adjustable wrench of claim 12, wherein the adjustable button is retained to the wrench body by the adjustment cover.

17. The adjustable wrench of claim 12, wherein a thread angle of the helical groove is less than a thread angle of the adjustment threaded sleeve.
